(19) United States
(12) Patent Application Publication
(10) Pub. No.: US 2010/0329095 A1
(43) Pub. Date: Dec. 30, 2010

(54) METHOD FOR DETERMINING RECORDING CONDITION OR REPRODUCING CONDITION, INTEGRATED CIRCUIT, AND OPTICAL DISK DEVICE

(75) Inventors: Masaya KUWAHARA, Hyogo (JP); Hiroyuki Yabuno, Osaka (JP); Masanori Nagata, Kyoto (JP); Takayuki Deai, Osaka (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/871,659

(22) Filed: Aug. 30, 2010

Related U.S. Application Data
(63) Continuation of application No. PCT/JP2009/001062, filed on Mar. 10, 2009.

(30) Foreign Application Priority Data
Mar. 28, 2008 (JP) 2008-088461

(51) Int. Cl. G11B 27/36

(52) U.S. Cl. 369/53.44

(57) ABSTRACT

A process which is performed by a recording/reproducing device configured to irradiate an optical recording medium including a plurality of recording layers with laser light to record and reproduce data, and is for determining at least one of a recording condition at the time of recording user data on any one recording object recording layer of the plurality of recording layers, or a reproducing condition at the time of reproducing the data from the recording object recording layer, where record management data indicating a recorded area on the recording layers is recorded on the optical recording medium. The process includes: acquiring a remaining capacity of a test recording area for each of the recording layers based on the record management data; and determining a recording layer on which test recording is intended to be made based on the remaining capacities of the test recording area acquired for the recording layers.

### CROSS-REFERENCE TO RELATED APPLICATION

This is a continuation of PCT International Application PCT/JP2009/001062 filed on Mar. 10, 2009, which claims priority to Japanese Patent Application No. 2008-088461 filed on Mar. 28, 2008. The disclosures of these applications including the specifications, the drawings, and the claims are hereby incorporated by reference in their entirety.

### BACKGROUND

The present invention relates to techniques to determine recording conditions and reproducing conditions by making test recording by recording/reproducing devices which irradiate optical recording media with laser light to record and reproduce data.

Japanese Patent Publication No. 2001-319332 describes an optical disk device which irradiates an optical disk including a plurality of recording layers with laser light by an optical pickup to reproduce data. In this optical disk device, the optical pickup is controlled by an electric circuit having an amplifier so that the gain of the amplifier at the time of reproducing data is determined for each recording layer.

Japanese Patent Publication No. 2007-179656 describes an optical disk device in which data is recorded on a recording medium having a plurality of recording areas. By this optical disk device, test recording to determine recording conditions is made in an area of the plurality of recording areas in which the best recording and reproduction characteristics are obtained.

### SUMMARY

Each recording layer of an optical recording medium having a plurality of recording layers such as the optical disk played back by the optical disk device of Japanese Patent Publication No. 2001-319332 generally includes a test recording area and a user data area, and in order to determine recording conditions and reproducing conditions of each recording layer, test recording is made in the test recording area of the relevant recording layer. Generally, the test recording area is smaller than the user data area.

Thus, if test recording is repeatedly made in the test recording area of one recording layer, the remaining capacity of the test recording area is reduced, so that the test recording can no longer be made. As a result, the recording conditions and the reproducing conditions of the recording layer can no longer be determined.

In particular, when a large number of files in small unit is recorded on a recordable disk such as a Blu-ray Disc Recordable (BD-R) disc, test recording is made for each file, so that the remaining capacity of the test recording area is more likely to be reduced. Moreover, a large number of files in small unit may be recorded on a recording layer, reducing the remaining capacity of the test recording area, whereas files in large unit may be recorded on another recording layer a small number of times, leaving a large capacity of the test recording area.

In view of the above problems, it is an objective of the present invention to prevent a situation where recording conditions and reproducing conditions cannot be determined due to the shortage of the remaining capacity of a test recording area by a recording/reproducing device for recording and reproducing data on an optical recording medium.

To solve the above problems, a method of the present invention which is performed by a recording/reproducing device configured to irradiate an optical recording medium including a plurality of recording layers with laser light to record and reproduce data, and is for determining at least one of a recording condition at the time of recording user data on any one recording object recording layer of the recording layers, or a reproducing condition at the time of reproducing the data from the recording object recording layer, where each of the recording layers has a test recording area and a user data area, and record management data indicating a recorded area on the recording layers is recorded on the optical recording medium includes: a remaining capacity acquiring step for acquiring a remaining capacity of the test recording area for each of the recording layers based on the record management data; a test recording layer determining step for determining a recording layer on which test recording is intended to be made as a test recording layer based on the remaining capacities of the test recording areas for the recording layers acquired in the remaining capacity acquiring step; a test recording step for making the test recording in the test recording area of the test recording layer determined in the test recording layer determining step; and a condition determining step for determining at least one of the recording condition or the reproducing condition based on recording quality of the area in which the test recording has been made in the test recording step.

With this process, even in the case of the shortage of the remaining capacity of the test recording area in the recording object recording layer, a recording layer different from the recording object recording layer can be determined as a test recording layer based on the remaining capacities of the test recording areas for the recording layers, and test recording can be made in the test recording area of the determined test recording layer. Thus, it is possible to prevent the situation where recording conditions and reproducing conditions cannot be determined due to the shortage of the remaining capacity of the test recording area. Moreover, the test recording areas can be effectively used, so that it is possible to increase the number of recording times.

According to the present invention, even in the case of the shortage of the remaining capacity of the test recording area in the recording object recording layer, test recording can be made on a test recording area of another recording layer, so that it is possible to prevent a situation where recording conditions and reproducing conditions cannot be determined due to the shortage of the remaining capacity of the test recording area. Moreover, the test recording areas can be effectively used, so that it is possible to increase the number of recording times.

### BRIEF DESCRIPTION OF THE DRAWINGS

FIG. 1 is a block diagram illustrating a configuration of an optical disk device according to a first embodiment of the present invention.

FIG. 2 is a view illustrating a format of a BD-R disc of the first embodiment.

FIG. 3 is a flowchart illustrating a method for determining recording conditions and reproducing conditions of the first embodiment.

FIG. 4 is a flowchart illustrating a process at (S1000) of FIG. 3 of the first embodiment.

FIG. 5 is a flowchart illustrating a process at (S2000) of FIG. 3 of the first embodiment.

FIG. 6 is a graph illustrating a drive waveform and a gate signal which are output from a driving unit when a record mark is formed on the BD-R disc of the first embodiment.

FIG. 7 is a view illustrating a configuration of a PIC area of the BD-R disc of the first embodiment.

FIG. 8 is a graph illustrating levels of a reproduction signal obtained when an area of the BD-R disc on which single-pattern data is recorded is played back in the first embodiment.

FIG. 9A is an example graph illustrating the relationship between the optical output level and the modulation factor of the first embodiment.

FIG. 9B is an example graph illustrating the relationship between the optical output level and the value obtained by multiplying the modulation factor by the optical output level of the first embodiment.

FIG. 10 is a flowchart illustrating a process at (S3000) of FIG. 3 of the first embodiment.

FIG. 11 is a view illustrating a method for making test recording at (S3003)-(S3007) of the first embodiment.

FIG. 12 is a flowchart illustrating a process at (S2000) of FIG. 3 by an optical disk device according to a second embodiment of the present invention.

FIG. 13 is a flowchart illustrating a process at (S2000) of FIG. 3 by an optical disk device according to a third embodiment of the present invention.

FIG. 14 is a flowchart illustrating a process at (S2000) of FIG. 3 by an optical disk device according to a fourth embodiment of the present invention.

FIG. 15 is a flowchart illustrating a process at (S2000) of FIG. 3 by an optical disk device according to a fifth embodiment of the present invention.

FIG. 16 is a flowchart illustrating a process performed by an optical disk device according to a sixth embodiment of the present invention instead of the process at (S0008) of FIG. 3.

FIG. 17 is a view illustrating a format of a DVD+R (Dual Layer) disc.

FIG. 18 is a view illustrating a format of the DVD+R disc on which a plurality of sessions is recorded.

### DETAILED DESCRIPTION

Embodiments of the present invention will be described below with reference to the drawings.

### First Embodiment

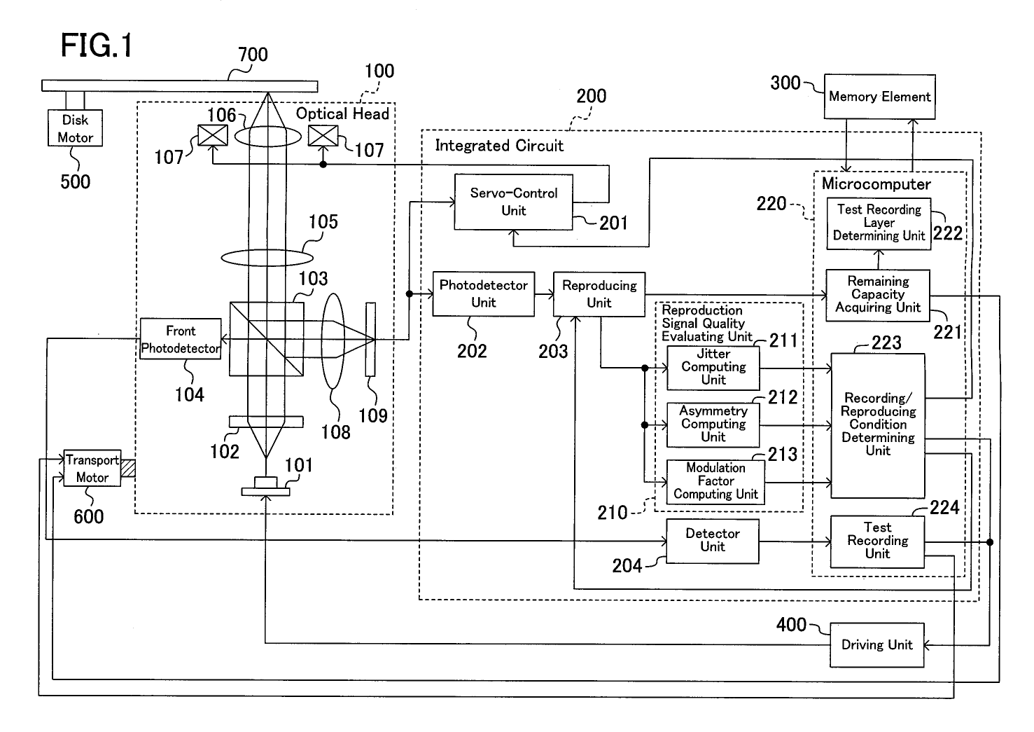

As illustrated in FIG. 1, an optical disk device (e.g. a recording/reproducing device) according to a first embodiment of the present invention includes an optical head 100, an integrated circuit 200, a memory element 300 for storing a computer program, a driving unit 400, a disk motor 500, and a transport motor 600 to record and reproduce data on an inserted BD-R disc 700 having a dual-layer structure.

<Format of BD-R Disc>

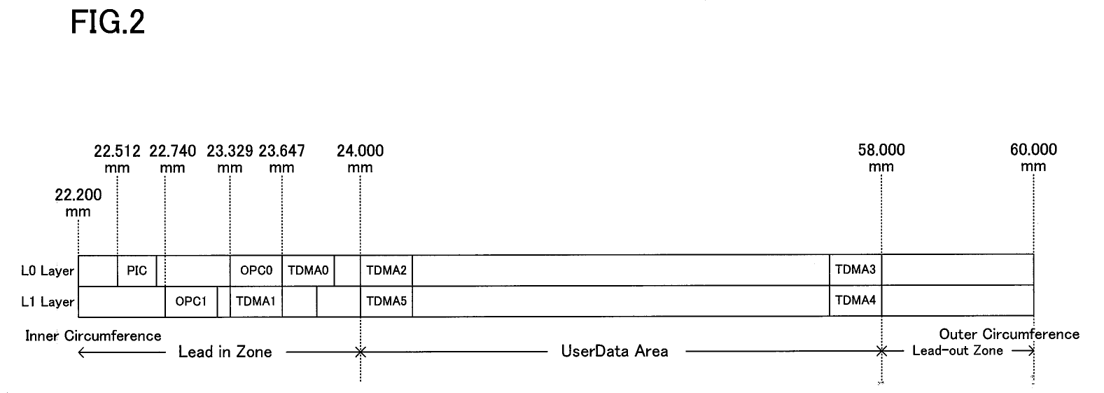

First, the format of the BD-R disc 700 which is a recording object of the optical disk device of the present embodiment will be described with reference to FIG. 2. The BD-R disc 700 has a format of a general BD-R disc.

As illustrated in FIG. 2, the BD-R disc 700 includes an L0 layer and an L1 layer. Each layer includes a lead-in area (represented by Lead in Zone in FIG. 2) extending from 24.00 mm (millimeter) in radius to the inner circumference, a user data area (represented by User Data Area in FIG. 2) extending from 24.00 mm to 58.00 mm in radius, and a lead-out area (represented by Lead-out Zone in FIG. 2) extending from 58.00 mm in radius to the outer circumference. Any user data can be recorded in the use data area. Disk information, for example, is previously recorded in the lead-in area and the lead-out area.

Moreover, each recording layer includes an optimum power control (OPC) area as a test recording area. As illustrated in FIG. 2, an OPC area (OPC0) of the L0 layer is an area from 23.329 mm to 23.647 mm in radius, and an OPC area (OPC1) of the L1 layer is an area from 22.740 mm to 23.067 mm in radius. Here, test recording means recording operation to properly adjust an optical output level and an optical pulse width at the time of recording user data.

Moreover, the BD-R disc 700 includes temporary disc management areas (represented by TDMAs in FIG. 2) as record management areas. The L0 layer includes, as the TDMA areas, TDMA0 (2048 physical clusters from a radius of 23.647 mm), TDMA2 (a maximum of 4096 physical clusters with n×256 physical clusters from a radius of 24.00 mm), and TDMA3 (n×256 physical clusters up to a radius of 58.00 mm). In contrast, the L1 layer includes, as the TDMA areas, TDMA1 (2048 physical clusters from a radius of 23.329 mm), TDMA4 (n×256 physical clusters up to a radius of 58.00 mm), and TDMA5 (a maximum of 4096 physical clusters with n×256 physical clusters from a radius of 24.00 mm). Here, record management data indicating recorded areas of the OPC areas and the user data areas is recorded in the TDMA areas in order of TDMA0, TDMA1, TDMA2, TDMA3, TDMA4, and TDMA5. Note that regardless of on which layer recording in the OPC area or the user data area is made, the TDMA areas are used in order of TDMA0, TDMA1, TDMA2, TDMA3, TDMA4, and TDMA5. Thus, even when recording in the OPC area or the user data area is made on the L1 layer, the record management data may be recorded in TDMA0 of the L0 layer. The optical disk device can detect the usage of the OPC areas and the user data areas by regenerating the record management data in the TDMA areas.

Moreover, in the L0 layer, a permanent information and control data (PIC) area extends from 22.512 mm in radius toward the outer circumference. Disk information representing the attribute of the disk, a recommended power, a recommended optical pulse width, and the like at the time of recording is recorded in the PIC area. The PIC area will be described in detail later.

<Optical Head 100>

The optical head 100 irradiates the BD-R disc 700 with laser light. Specifically, the optical head 100 includes a semiconductor laser 101, a collimator lens 102, a polarization beam splitter (PBS) 103, a front photodetector 104, a wave plate 105, an objective lens 106, an actuator 107, a detection lens 108, and a plus/minus-first-order light detector 109.

The semiconductor laser 101 is a light source which outputs a light beam having a light intensity required for reproduction and recording, for example, laser light having a wavelength of 405 nm according to a current output from the driving unit 400.

The actuator 107 controls the objective lens 106 to move in a focus direction and in a track direction, and controls the objective lens 106 to tilt to a recording surface.

The laser light output from the semiconductor laser 101 (outgoing light) is made into parallel light by the collimator lens 102, and split by the PBS 103. Then, the split light rays pass through the wave plate 105, and are gathered by the objective lens 106 on the BD-R disc 700, thereby forming a light beam spot at the position on which the split light rays are gathered. Here, part of the laser light entering the PBS 103 is detected by the front photodetector 104, and converted to an electrical signal.

Meanwhile, reflected light from the BD-R disc 700 passes through the objective lens 106 and the wave plate 105, is split by the PBS 103 from the light path of the outgoing light, and is guided to the detection lens 108. The detection lens 108 guides plus-first-order light for detecting a focus error signal and minus-first-order light for detecting a tracking error signal to the plus/minus-first-order light detector 109. The plus/minus-first-order light detector 109 converts the plus-first-order light and the minus-first-order light which are guided by the detection lens 108 to electrical signals, and outputs the electrical signal.

<Integrated Circuit 200>

The integrated circuit 200 includes a servo-control unit 201, a photodetector unit 202, a reproducing unit 203, a detector unit 204, a reproduction signal quality evaluating unit 210, and a microcomputer 220. The reproduction signal quality evaluating unit 210 includes a jitter computing unit 211, an asymmetry computing unit 212, and a modulation factor computing unit 213. The microcomputer 220 includes a remaining capacity acquiring unit 221, a test recording layer determining unit 222, a recording/reproducing condition determining unit 223, and a test recording unit 224.

The servo-control unit 201 performs focus control and tracking control according to the electrical signals output from the plus/minus-first-order light detector 109. The focus control and the tracking control are carried out by driving the actuator 107. Moreover, the servo-control unit 201 changes target positions (focus offset and tracking offset) of the focus control and the tracking control, the inclination (tilt) of the objective lens 106, and aberration according to an instruction from the recording/reproducing condition determining unit 223 and the test recording unit 224 of the microcomputer 220 which will be described later.

The photodetector unit 202 generates a reproduction signal for reproducing data (address information, user data, etc.) recorded on the BD-R disc 700 based on part or the entirety of the electrical signal output from the plus/minus-first-order light detector 109.

The reproducing unit 203 performs signal processing such as equalization by an equalizer circuit on the reproduction signal generated by the photodetector unit 202.

The detector unit 204 detects the electrical signal obtained from the front photodetector 104 to output an optical output level according to a reproducing state or a recording state.

The reproduction signal quality evaluating unit 210 evaluates the quality of the reproduction signal after the signal processing by the reproducing unit 203. Specifically, the reproduction signal quality evaluating unit 210 includes the jitter computing unit 211 for computing a jitter value, the asymmetry computing unit 212 for computing an asymmetry value, and the modulation factor computing unit 213 for computing a modulation factor.

The remaining capacity acquiring unit 221 receives the reproduction signal after the signal processing by the reproducing unit 203. Then, based on the record management data (data read out of the TDMA areas) indicated by the reproduction signal, the remaining capacity acquiring unit 221 acquires the remaining capacity of the OPC area of the BD-R disc 700 (the remaining capacity of a recordable area in the OPC area) for each of the recording layers. Moreover, the remaining capacity acquiring unit 221 outputs a driving signal which moves the light beam spot to the OPC area, the PIC area, the TDMA area, or the user data area.

Based on the remaining capacities of the OPC areas acquired by the remaining capacity acquiring unit 221 for each of the recording layers, the test recording layer determining unit 222 determines that a recording layer on which test recording is intended to be made is a test recording layer.

Based on a jitter value, an asymmetry value, and a modulation factor (the recording quality of the test-recorded area) which are computed by the reproduction signal quality evaluating unit 210, the recording/reproducing condition determining unit 223 determines recording conditions at the time of recording user data on any one recording object recording layer of the plurality of recording layers, and reproducing conditions at the time of reproducing the data from the recording object recording layer. Specifically, as the recording conditions, the recording/reproducing condition determining unit 223 determines an optical output level and an optical pulse width of laser light with which the optical head 100 irradiates the BD-R disc 700, and according to the result of the determination, gives an instruction to the driving unit 400. As the reproducing conditions, the recording/reproducing condition determining unit 223 determines target positions (offsets) of the focus control and the tracking control, the tilt of the objective lens 106, the gain inside the servo-control unit 201, and aberration, and according to the result of the determination, gives an instruction to the servo-control unit 201. Moreover, as the reproducing conditions, the recording/reproducing condition determining unit 223 further determines a boost value (gain), a cutoff frequency, and the like of the equalizer circuit of the reproducing unit 203, and according to the result of the determination, gives an instruction to the reproducing unit 203.

The test recording unit 224 outputs a laser driving instruction and a pulse instruction to the driving unit 400 according to the reproducing state or the recording state in order to control the optical output level and the optical pulse width of the semiconductor laser 101. Moreover, the test recording unit 224 controls the driving unit 400 and the transport motor 600 to indirectly control the optical head 100 so that test recording is made in the OPC area of the test recording layer determined by the test recording layer determining unit 222.

The function of each unit of the microcomputer 220 is carried out by executing the computer program stored in the memory element 300. Moreover, the memory element 300 can start the computer program according to an instruction from the microcomputer 220.

The driving unit 400 outputs a current according to the laser driving instruction and the pulse instruction output from the test recording unit 224 of the integrated circuit 200. The driving unit 400 changes the amount of the output current so that the semiconductor laser 101 can irradiate the BD-R disc 700 with outgoing light having an intensity required for reproduction and recording.

The disk motor 500 rotates the BD-R disc 700 at a set number of rotations.

The transport motor 600 moves the optical head 100 in a direction transverse to the track of the BD-R disc 700 according to driving signals output from the remaining capacity acquiring unit 221 and the test recording unit 224 of the microcomputer 220, thereby allowing the optical head 100 to be arranged at a set position.

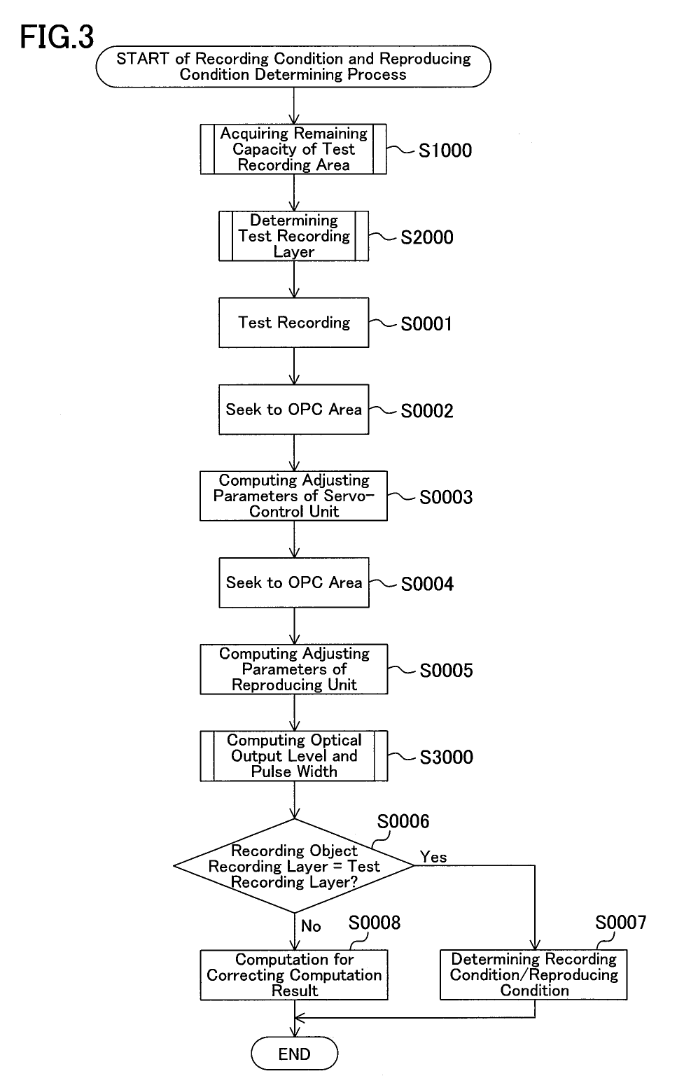

Here, a method for determining the recording conditions and the reproducing conditions by the optical disk device configured as described above will be described with reference to the flowchart of FIG. 3. Note that operation for determining the recording conditions and the reproducing conditions of FIG. 3 is carried out when starting a series of operation for recording user data on any one recording layer (hereinafter referred to as “recording object recording layer”) of a plurality of recording layers.

Upon inserting the BD-R disc 700 in the optical disk device, the optical disk device starts operating. Then, laser light output from the semiconductor laser 101 is gathered by servo control to a predetermined position on the BD-R disc 700. Then, based on a data recording state, and the like on the BD-R disc 700, the microcomputer 220 determines whether or not test recording is required to be made. Such determination is made based on, for example, the size of last recorded user data, and whether or not the last recorded user data is data recorded using the same optical disk device. If it is determined that the test recording is required to be made, the operation illustrated in the flowchart of FIG. 3 starts.

First, at (S1000), the optical disk device acquires the remaining capacity of the OPC area for each recording layer of the BD-R disc 700.

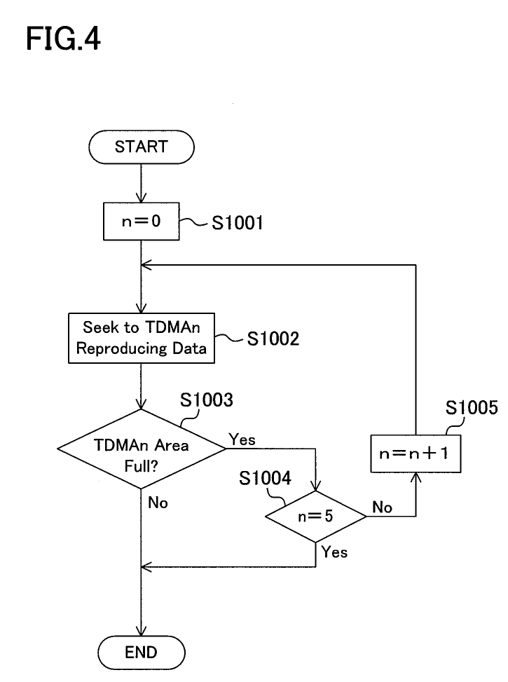

FIG. 4 is a flowchart illustrating the process at (S1000) in detail.

At (S1000), the optical disk device first sets n to an initial value of 0 at (S1001), allows the optical head 100 to seek such that a light beam spot is located at TDMAn to reproduce data in TDMAn at (S1002), and determines whether or not the entirety of TDMAn is recorded at (S1003). Then, if the entirety of TDMAn is recorded, the optical disk device determines whether or not n=5 at (S1004). If n=5, the process is terminated, but if not, a process is performed so that n=n+1 at (S1005), and the process proceeds back to (S1002). Specifically, the optical disk device first reproduces data in TDMA0, and determines here whether or not the entirety of TDMA0 is recorded. If the entirety of TDMA0 is recorded, the optical disk device further reproduces data in TDMA1. Then, the process is repeated until an unrecorded TDMA area is found, or until data in TDMA5 is reproduced. Then, the remaining capacity acquiring unit 221 of the optical disk device acquires the remaining capacities of the OPC0 and the OPC1 based on the record management data read out of the TDMA areas.

Next, at (S2000) in FIG. 3, the test recording layer determining unit 222 determines ob which one of the recording layers test recording is intended to be made in the OPC area based on the remaining capacities of the OPC areas of the recording layers acquired at (S1000). That is, a recording layer on which the test recording is intended to be made is determined as a test recording layer.

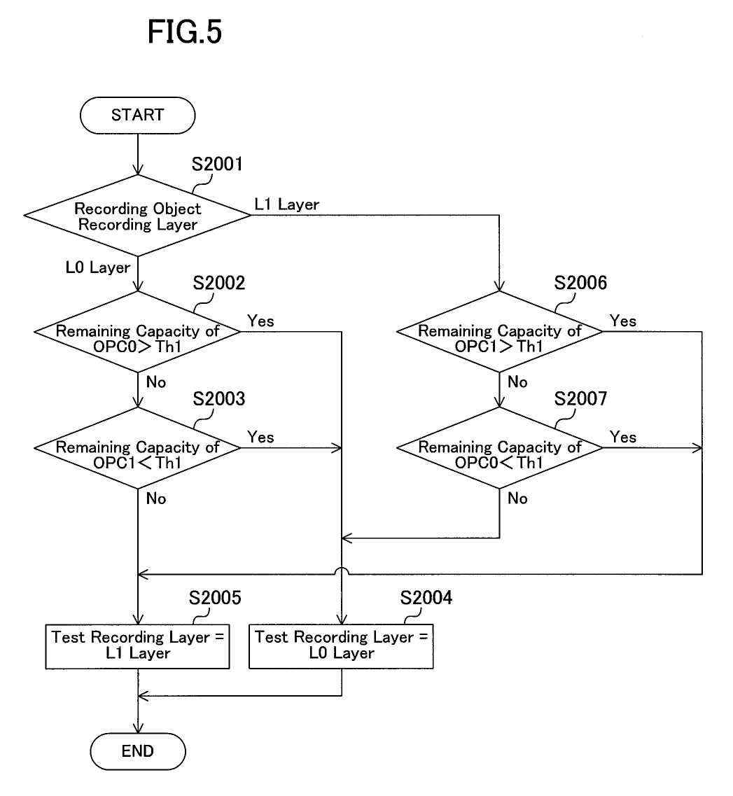

FIG. 5 is a flowchart illustrating the process at (S2000) in detail.

At (S2000), the test recording layer determining unit 222 first determines at (S2001) whether the recording object recording layer is the L0 layer or the L1 layer. If the recording object recording layer is the L0 layer, the test recording layer determining unit 222 determines at (S2002) whether or not the remaining capacity of the OPC0 is larger than a predetermined value Th1. If the remaining capacity of the OPC0 is equal to or smaller than the predetermined value Th1, the process proceeds to (S2003). If the remaining capacity of the OPC0 is larger than the predetermined value Th1, the test recording layer determining unit 222 determines at (S2004) that an OPC area in which the test recording is intended to be made is the OPC0, i.e., the OPC area of the L0 layer. The test recording layer determining unit 222 determines at (S2003) whether or not the remaining capacity of the OPC1 is smaller than the predetermined value Th1. If the remaining capacity of the OPC1 is equal to or larger than the predetermined value Th1, the test recording layer determining unit 222 determines at (S2005) that the OPC area in which the test recording is intended to be made is the OPC1, i.e., the OPC area of the L1 layer. However, if the remaining capacity of the OPC1 is smaller than the predetermined value Th1, the test recording layer determining unit 222 determines at (S2004) that the OPC area in which the test recording is intended to be made is the OPC0, i.e., the OPC area of the L0 layer.

In contrast, if it is determined at (S2001) that the recording object recording layer is the L1 layer, the test recording layer determining unit 222 determines at (S2006) whether or not the remaining capacity of the OPC1 is larger than the predetermined value Th1. If the remaining capacity of the OPC1 is equal to or smaller than the predetermined value Th1, the process proceeds to (S2007). If the remaining capacity of the OPC1 is larger than the predetermined value Th1, the test recording layer determining unit 222 determines at (S2005) that the OPC area in which the test recording is intended to be made is the OPC1, i.e., the OPC area of the L1 layer. The test recording layer determining unit 222 determines at (S2007) whether or not the remaining capacity of the OPC0 is smaller than the predetermined value Th1. Then, if the remaining capacity of the OPC0 is smaller than the predetermined value Th1, the test recording layer determining unit 222 determines at (S2005) that the OPC area in which the test recording is intended to be made is the OPC1, i.e., the OPC area of the L1 layer. However, if the remaining capacity of the OPC0 is equal to or larger than the predetermined value Th1, the test recording layer determining unit 222 determines at (S2004) that the OPC area in which the test recording is intended to be made is the OPC0, i.e., the OPC area of the L0 layer.

Then, at (S0001) of FIG. 3, the optical disk device makes the test recording in the OPC area of the test recording layer determined at (S2000).

Next, at (S0002), the optical disk device allows the optical head 100 to seek to the OPC area in which the test recording has been made at (S0001).

Next, at (S0003), the recording/reproducing condition determining unit 223 computes adjusting parameters inside the servo-control unit 201 according to the jitter value, the asymmetry value, and the modulation factor (the recording quality of the test-recorded area) which are computed by the reproduction signal quality evaluating unit 210. The adjusting parameters computed here are the target positions of the focus control and the tracking control, the tilt of the objective lens 106, the gain inside the servo-control unit 201, aberration, and the like.

Furthermore, at (S0004), the optical disk device allows the optical head 100 again to seek to the OPC area in which the test recording has been made at (S0001).

Then, at (S0005), the recording/reproducing condition determining unit 223 computes adjusting parameters inside the reproducing unit 203 according to the jitter value, the asymmetry value, and the modulation factor (the recording quality of the test-recorded area) which are computed by the reproduction signal quality evaluating unit 210. The adjusting parameters computed here are circuit constants of an equalizer circuit for equalizing the reproduction signal generated by the photodetector unit 202, that is, the reproduction signal obtained by reproducing user data, the amplitude level of the reproduction signal, and the like. As the circuit constants of the equalizer circuit, a boost value (gain), a cutoff frequency, and the like are computed.

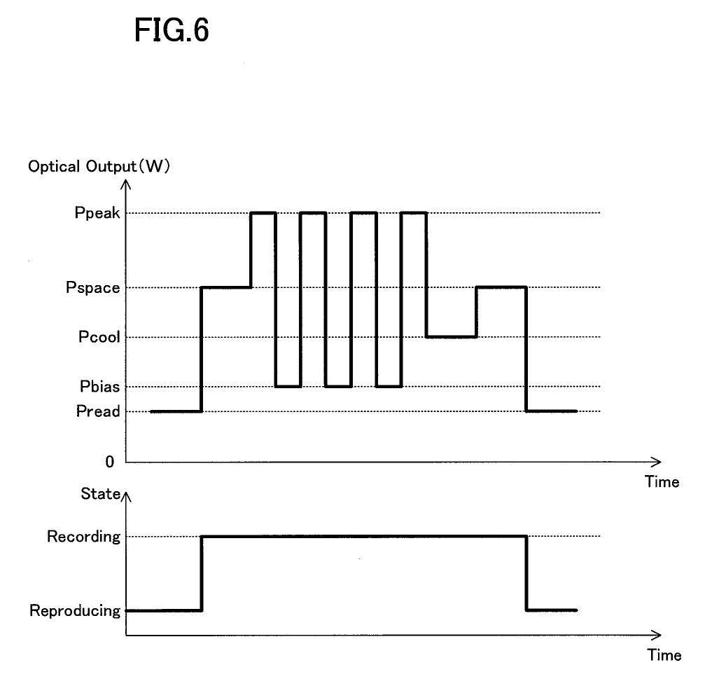

Next, at (S3000), the recording/reproducing condition determining unit 223 computes optical output levels Ppeak, Pspace, Pcool, and Pbias, and an optical pulse width illustrated in FIG. 6 based on the modulation factor (recording quality of the test-recorded area) computed by the reproduction signal quality evaluating unit 210. FIG. 6 illustrates a drive waveform which the driving unit 400 outputs to semiconductor laser 101 when a record mark is formed on the BD-R disc 700, and a waveform of a gate signal in the recording state and the reproducing state. If the optical output levels and the optical pulse width are not properly set, a record mark which cannot be reproduced may be formed when recording is made on the BD-R disc 700.

The recording/reproducing condition determining unit 223 computes the optical output levels Ppeak, Pspace, Pcool, and Pbias using the following equations (1)-(4).

Ppeak=Pth×κ×ρ (1)

Pspace=Ppeak×εs (2)

Pcool=Ppeak×εc (3)

Pbias=Ppeak×εbw (4)

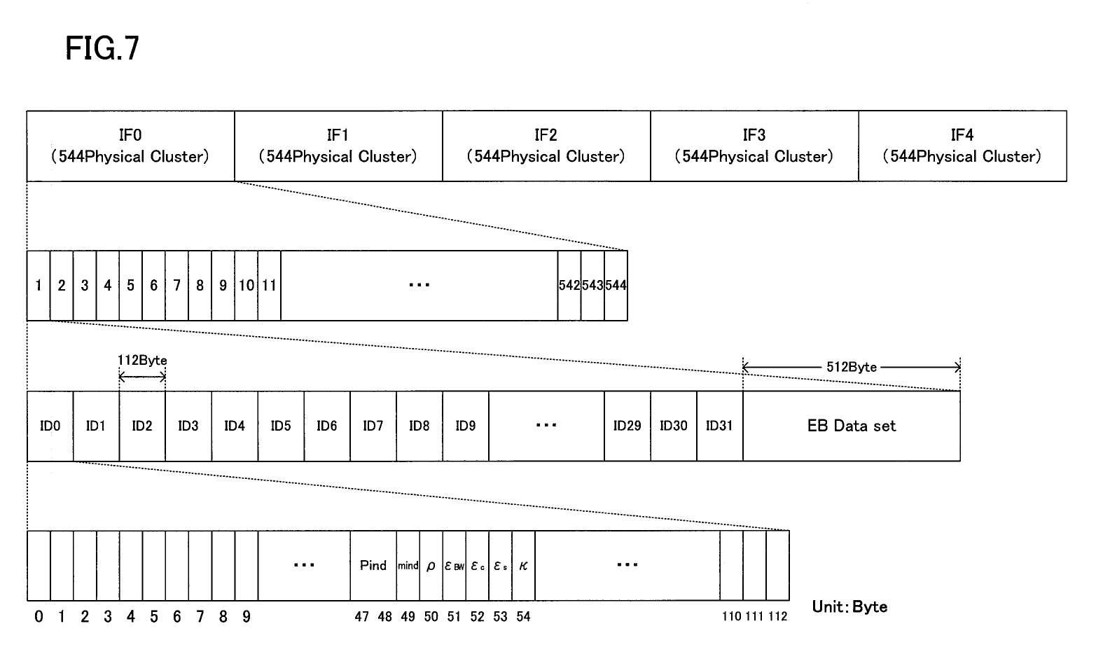

These coefficients κ, ρ, εs, εc, and εbw can be obtained by reproducing information in the PIC area illustrated in FIG. 2. FIG. 7 is a view illustrating a configuration of the PIC area of the BD-R disc 700. The PIC area includes five information flags (IFs). Each information flag includes 544 physical clusters. Each physical cluster includes 32 pieces of ID information (ID). Each piece of ID information includes 112 bytes. The coefficients κ, ρ, εs, δc, and εbw in the equations (1)-(4) above are recorded in 50-54 bytes of the ID information. Thus, the optical disk device can acquire the coefficients κ, ρ, εs, εc, and εbw by reproducing the PIC area when computing the optical output levels.

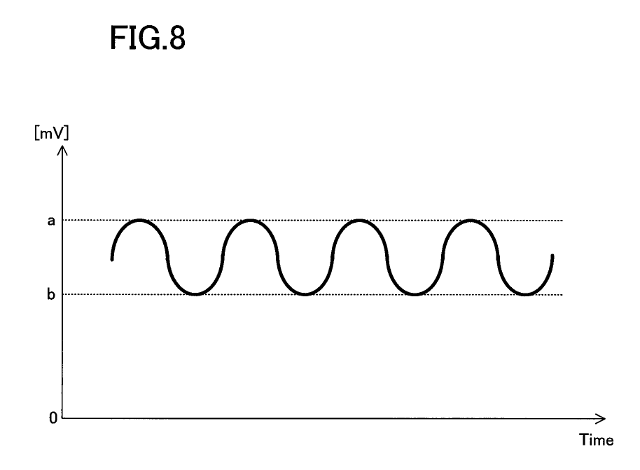

Here, the modulation factor will be described. FIG. 8 is a graph illustrating the level of a reproduction signal obtained when an area of the BD-R disc 700 in which single-pattern data is recorded is played back, that is, the output level of the photodetector unit 202. The output level of the plus/minus-first-order beam detector 109 also has the same waveform. Zero on the vertical axis indicates the signal level of an unrecorded area. The modulation factor can be computed by using the following equation (5).

Modulation Factor=(a−b)/(a+b) (5)

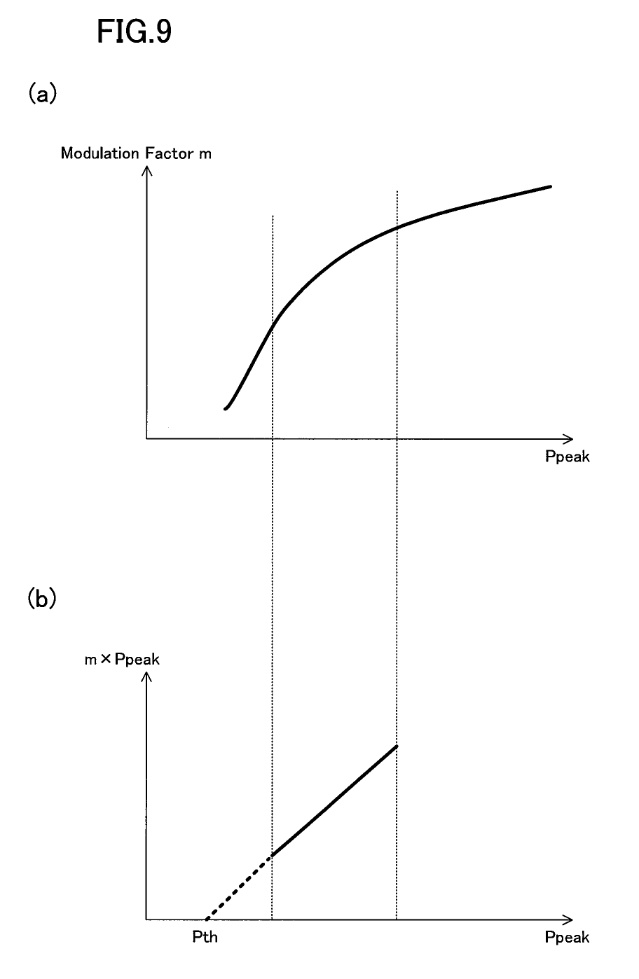

FIG. 9A is an example graph in which the horizontal axis indicates the optical output level Ppeak, and the vertical axis indicates the modulation factor m computed based on the reproduction signal of a record mark recorded at the corresponding optical output level. Moreover, FIG. 9B is an example graph in which the horizontal axis indicates the optical output level Ppeak, and the vertical axis indicates the value m×Ppeak obtained by multiplying the modulation factor m of the vertical axis of FIG. 9A by the optical output level Ppeak.

The optical disk device makes test recording while changing the optical output level Ppeak, and plays back the test-recorded area to obtaining a reproduction signal. Based on the obtained reproduction signal, the optical disk device computes a modulation factor corresponding to each optical output level. In this way, it is possible to obtain the relation ship between the optical output level Ppeak and the modulation factor m as illustrated in FIG. 9A. Then, the operation of converting the value of the vertical axis to m×Ppeak is carried out so that the relationship between the optical output level Ppeak and m×Ppeak is approximated to a linear approximate expression. Then, as illustrated in FIG. 9B, a value at an x-axis intercept of the graph indicating the approximate expression is determined to be Pth. By substituting the thus determined Pth into the above equations (1)-(4), the optical output levels Ppeak, Pspace, Pcool, and Pbias can be computed.

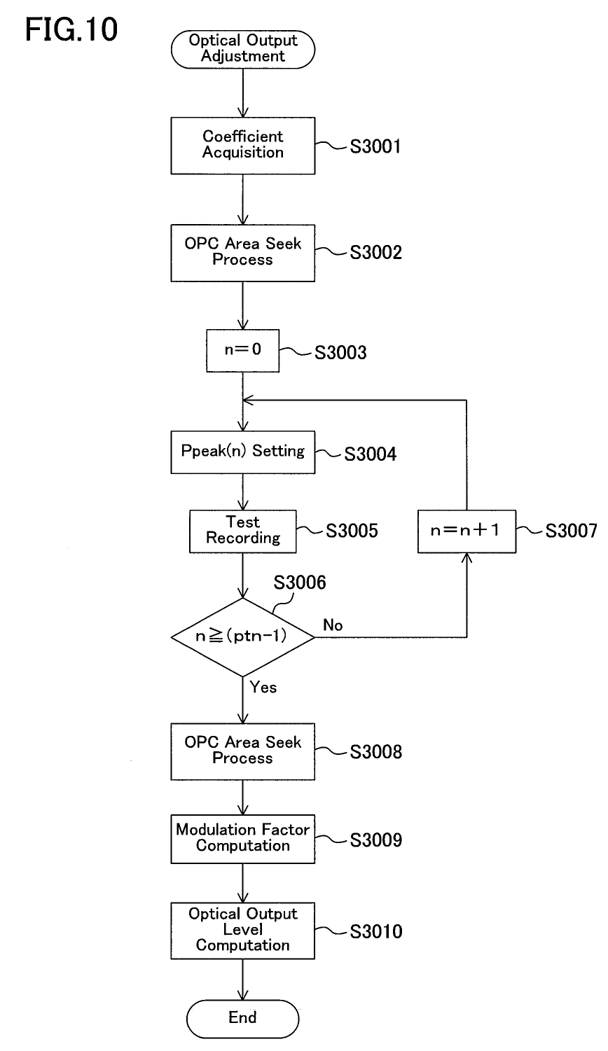

FIG. 10 is a flowchart illustrating a process for computing the optical output level at (S3000) in detail.

First, at (S3001), the optical disk device allows the optical head 100 to seek to the PIC area to obtain the coefficients κ, ρ, εs, εc, and εbw required for optical output adjustment. Next, at (S3002), the optical disk device allows the optical head 100 to seek to the OPC area of the test recording layer determined at (S2000). At (S3003), the optical disk device resets the internal variable n to 0. Subsequently, the optical disk device sets the optical output level Ppeak to Ppeak(n) at (S3004), and makes test recording at (S3005). At (S3006), the optical disk device determines whether or not n≧ptn−1. If not n≧ptn−1, then 1 is added to n at (S3007). If n≧ptn−1, the process proceeds to (S3008). Thus, at (S3003)-(S3007), the test recording is made at ptn types of optical output levels.

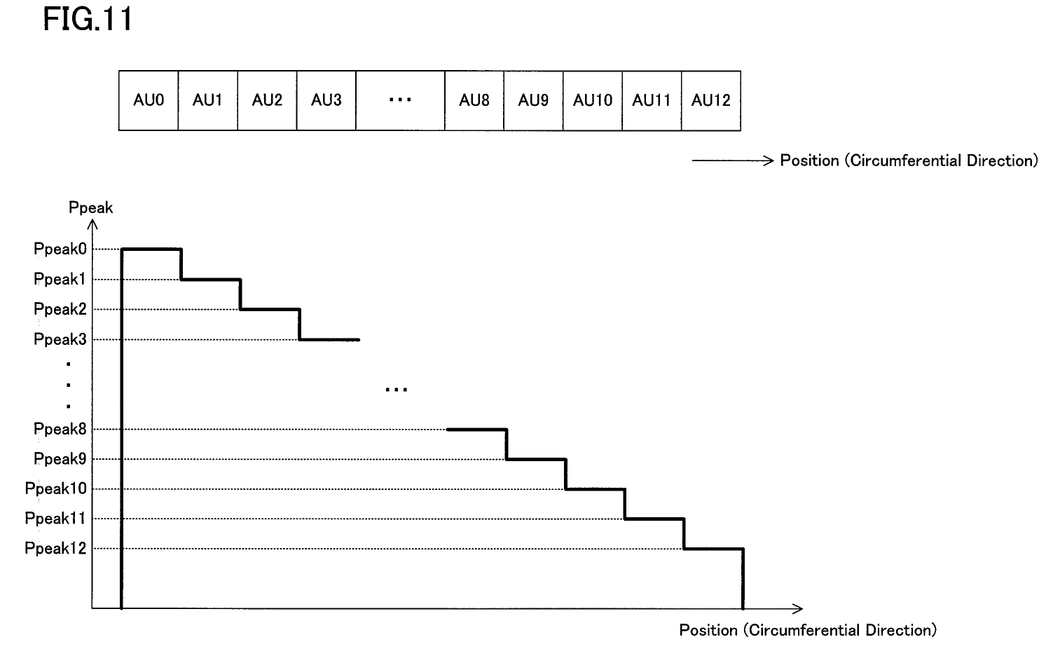

For example, the optical disk device sets ptn to 13 at (S3003)-(S3007), and makes test recording so that the relationship between an address of the BD-R disc 700 on which the test recording is made and the optical output level Ppeak shown in FIG. 11 is obtained. In this example, test recording corresponding to one type of optical output level is made on one AU area. First, the Ppeak is set to Ppeak0, and test recording is made on a first address AU0 of the OPC area. Subsequently, the Ppeak is changed to Ppeak1, and test recording is made on a second address AU1. Then, test recording is thus repeated to Ppeak12.

Note that the range from Ppeak0 to Ppeak12 is set in consideration of variations of characteristics of the semiconductor laser 101, variations of recording characteristics of the BD-R disc 700, and the like. For example, when variations of the characteristics of the semiconductor laser 101 and of the recording characteristics of the BD-R disc 700 are small, the range from Ppeak0 to Ppeak12 may be small. Moreover, when the target precision of the adjustment of the recording/reproducing condition determining unit 223 is low, the range from Ppeak(n) to Ppeak(n+1) may be large. Thus, the value of ptn is not limited to 13.

Then, at (S3008), the optical disk device allows the optical head 100 to seek to the area in which the test recording has been made at (S3003)-(S3007). At (S3009), the optical disk device computes a modulation factor of the area. Specifically, the modulation factor is computed for each of AUs in the segment from AU0 to AU12 shown in FIG. 11 by using the above equation (5). Note that the optical output level Ppeak may not be necessarily set to have a step shape as shown in FIG. 11. Moreover, test recording may not necessarily be made on each AU, but may be made in each area in another unit.

Subsequently, at (S3010), the recording/reproducing condition determining unit 223 computes Pth based on the relationship between the optical output level Ppeak and m×Ppeak as described above with reference to FIGS. 9A and 9B. By substituting the computed Pth into the equations (1)-(4), the optical output levels Ppeak, Pspace, Pcool, and Pbias are computed.

Next, at (S0006) of FIG. 3, the recording/reproducing condition determining unit 223 determines whether or not the test recording layer determined at (S2000) corresponds to the recording object recording layer. Then, if the test recording layer determined at (S2000) corresponds to the recording object recording layer, the recording/reproducing condition determining unit 223 determines at (S0007) that the adjusting parameters computed at (S0003) and (S0005) are the reproducing conditions at the time of reproducing data of the recording object recording layer, and the optical output level and the optical pulse width computed at (S3000) are the recording conditions at the time of recording user data in the recording object recording layer.

In contrast, if at (S0006) of FIG. 3, the recording/reproducing condition determining unit 223 determines that the test recording layer determined at (S2000) does not correspond to the recording object recording layer, the process proceeds to (S0008). Then, the adjusting parameters, the optical output levels, and the optical pulse width computed at (S0003), (S0005), and (S3000) are corrected at (S0008). Specifically, the focus control target position and the tilt of the objective lens 106 computed at (S0003), the boost value and the cutoff frequency of the equalizer circuit computed at (S0005), and the optical output levels Ppeak, Pspace, Pcool, and Pbias computed at (S3000) are corrected using values shown in upper two columns of Table 1 below. The values in Table 1 are previously stored in the optical disk device.

TABLE 1

| | Servo-Control Unit | | Reproducing Unit | | Optical Output |
|---|---|---|---|---|---|
| Ratio | Fbal | Tilt | Boost | fc | Pth |
| L0/L1 | α01 | α02 | α03 | α04 | α05 |
| L1/L0 | α11 | α12 | α13 | α14 | α15 |
| L0/L2 | β01 | β02 | β03 | β04 | β05 |
| L2/L0 | β21 | β22 | β23 | β24 | β25 |
| L1/L2 | γ11 | γ12 | γ13 | γ14 | γ15 |
| L2/L1 | γ21 | γ22 | γ23 | γ24 | γ25 |

First, description will be given of the case where the optical disk device attempts to record user data on the L0 layer (the recording object recording layer is the L0 layer), but test recording is made in the OPC area of the L1 layer due to the shortage of the remaining capacity of the OPC area of the L0 layer. Here, the focus control target position and the tilt of the objective lens 106 which are computed at (S0003) are respectively denoted by Fbal1 and Tilt1, the boost value of the equalizer circuit and the cutoff frequency of the equalizer circuit which are computed at (S0005) are respectively denoted by Boost1 and fc1, and the optical output levels Ppeak, Pspace, Pcool, and Pbias which are computed at (S3000) are denoted by Pth1. Moreover, the focus control target position, the tilt of the objective lens 106, the boost value (gain) of the equalizer circuit, the cutoff frequency of the equalizer circuit, and the optical output levels after the correction which correspond to the L0 layer are respectively denoted by Fbal0, Tilt0, Boost0, fc0, and Pth0. Then, the recording/reproducing condition determining unit 223 determines the focus control target position Fbal0, the tilt Tilt0 of the objective lens 106, the boost value (gain) Boost0 of the equalizer circuit, the cutoff frequency fc0 of the equalizer circuit, and the optical output level Pth0 corresponding to the L0 layer which is the recording object recording layer using equations (6)-(10) below.

Fbal0=Fbal1×α01 (6)

Tilt0=Tilt1×α02 (7)

Boost0=Boost1×α03 (8)

fc0=fc1×α04 (9)

Pth0=Pth1×α05 (10)

Note that in the opposite case, that is, when test recording is made on the L0 layer, and user data is recorded on the L1 layer (the recording object recording layer is the L1 layer), the determination is made using equations (11)-(15) below instead of the equations (6)-(10).

Fbal1=Fbal0×α11 (11)

Tilt1=Tilt0×α12 (12)

Boost1=Boost0×α13 (13)

fc1=fc0×α14 (14)

Pth1=Pth0×α15 (15)

That is, at (S0008), the recording/reproducing condition determining unit 223 corrects the focus control target position and the tilt of the objective lens 106 computed at (S0003), the boost value and the cutoff frequency of the equalizer circuit computed at (S0005), and the optical output levels Ppeak, Pspace, Pcool, and Pbias computed at (S3000) according to the combination of the test recording layer determined at (S2000) (the recording layer on which test recording has been made at (S0001) and (S3000)) and the recording object recording layer. In this way, the combination of the test recording layer and the recording object recording layer is taken into consideration in addition to the recording quality of the area in which the test recording has been made at (S0001) and (S3000), so that the recording conditions and the reproducing conditions can be more properly determined.

Note that even when using a recording medium having three recording layers instead of the BD-R disc 700, a similar corrections can be made by using many variables as shown in lower four columns of Table 1.

Thus, according to the present embodiment, if the remaining capacity of an OPC area of a recording object recording layer is larger than Th1, recording conditions and reproducing conditions can be determined with high precision using the OPC area of the recording object recording layer. In contrast, if the remaining capacity of the OPC area of the recording object recording layer is equal to or smaller than Th1, it is determined whether or not the remaining capacity of an OPC area of the other recording layer is smaller than Th1. If the remaining capacity of the OPC area of the other recording layer is not smaller than Th1, it is possible to determine the recording conditions and the reproducing conditions using the OPC area of the other recording layer. Thus, the possibility that the recording conditions and the reproducing conditions cannot be determined due to the shortage of the remaining capacity of the OPC area of the recording object recording layer is smaller in comparison to conventional configurations. Moreover, the OPC area can be used more effectively in comparison to conventional configurations, so that it is possible to increase the number of recording times.

Moreover, the optical disk device of the present embodiment determines the optical output levels and the optical pulse width at the time of recording user data, so that the quality of the record mark representing the user data is improved.

Moreover, the optical disk device of the present embodiment determines the boost value of the equalizer circuit for equalizing the reproduction signal obtained by reproducing user data, the focus offset, the tracking offset, the tilt of the objective lens for gathering laser light with which the BD-R disc 700 is irradiated, the aberration, and the like, so that recorded data recorded under various conditions can be reproduced with high precision.

### Second Embodiment

In an optical disk device according to a second embodiment of the present invention, a remaining capacity acquiring unit 221 further acquires the remaining capacity of a user data area in addition to the remaining capacity of an OPC area for each of recording layers based on the record management data. Moreover, based on the remaining capacities of the user data areas for the recording layers in addition to the remaining capacities of the OPC areas for the recording layers acquired by the remaining capacity acquiring unit 221, a test recording layer determining unit 222 determines a recording layer on which test recording is intended to be made as a test recording layer.

In the optical disk device of the present embodiment, the remaining capacity acquiring unit 221 further acquires the remaining capacity of the user data area in addition to the remaining capacity of the OPC area for each of the recording layers at (S1000). Here, the remaining capacity of the OPC area may be acquired first, or the remaining capacity of the user data area may be acquired first.

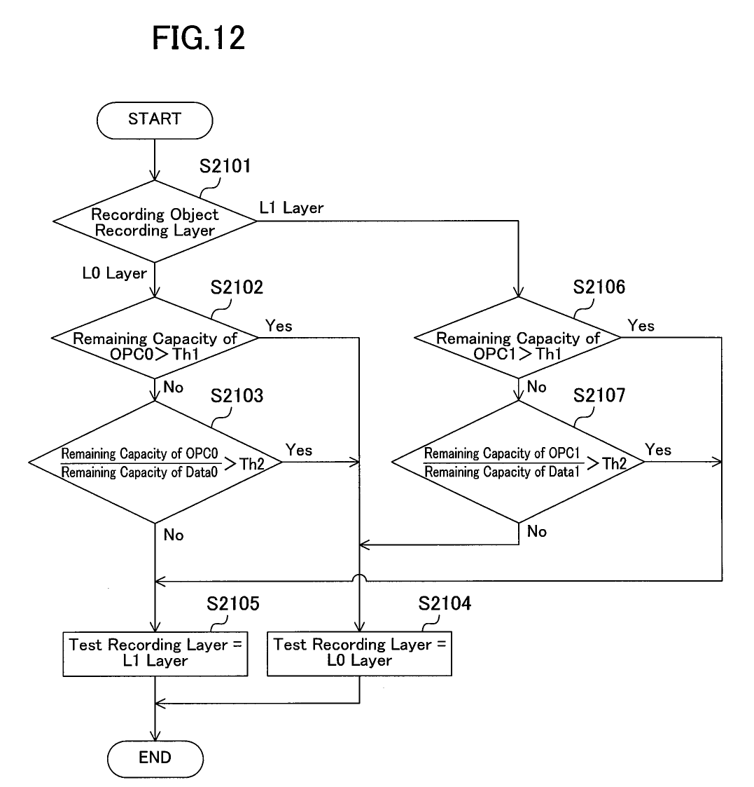

Moreover, in the optical disk device of the present embodiment, the test recording layer determining unit 222 performs the process illustrated in FIG. 12 at (S2000) instead of the process of FIG. 5 of the first embodiment.

The test recording layer determining unit 222 first determines at (S2101) whether the recording object recording layer is an L0 layer or an L1 layer. If the recording object recording layer is the L0 layer, the test recording layer determining unit 222 determines at (S2102) whether or not the remaining capacity of the OPC0 is larger than a predetermined value Th1. If the remaining capacity of the OPC0 is equal to or smaller than the predetermined value Th1, the process proceeds to (S2103). If the remaining capacity of the OPC0 is larger than the predetermined value Th1, the test recording layer determining unit 222 determines at (S2104) that an OPC area in which the test recording is intended to be made is the OPC0, i.e., the OPC area of the L0 layer. At (S2103), the test recording layer determining unit 222 determines whether or not the proportion of the remaining capacity of the OPC0 to the remaining capacity of a user data area Data0 of the L0 layer is larger than a predetermined value Th2. Then, if the proportion is larger than the predetermined value Th2, the test recording layer determining unit 222 determines at (S2104) that the OPC area in which the test recording is intended to be made is the OPC0, i.e., the OPC area of the L0 layer. However, if the proportion is equal to or smaller than the predetermined value Th2, the test recording layer determining unit 222 determines at (S2105) that the OPC area in which the test recording is intended to be made is an OPC1, i.e., the OPC area of the L1 layer. In contrast, if it is determined at (S2101) that the recording object recording layer is the L1 layer, the test recording layer determining unit 222 determines at (S2106) whether or not the remaining capacity of the OPC1 is larger than the predetermined value Th1. If the remaining capacity of the OPC1 is equal to or smaller than the predetermined value Th1, the process proceeds to (S2107). If the remaining capacity of the OPC1 is larger than the predetermined value Th1, the test recording layer determining unit 222 determines at (S2105) that the OPC area in which the test recording is intended to be made is the OPC1, i.e., the OPC area of the L1 layer. At (S2107), the test recording layer determining unit 222 determines whether or not the proportion of the remaining capacity of the OPC1 to the remaining capacity of a user data area Data1 of the L1 layer is larger than the predetermined value Th2. Then, if the proportion is larger than the predetermined value Th2, the test recording layer determining unit 222 determines at (S2105) that the OPC area in which the test recording is intended to be made is the OPC1, i.e., the OPC area of the L1 layer. However, if the proportion is equal to or smaller than the predetermined value Th2, the test recording layer determining unit 222 determines at (S2104) that the OPC area in which the test recording is intended to be made is the OPC0, i.e., the OPC area of the L0 layer.

The other configuration and operation of the optical disk device of the present embodiment are the same as those of the first embodiment, and thus the detailed description thereof is omitted.

Thus, according to the present embodiment, if the remaining capacity of an OPC area of a recording object recording layer is larger than Th1, recording conditions and reproducing conditions can be determined with high precision using the OPC area of the recording object recording layer. In contrast, if the remaining capacity of the OPC area of the recording object recording layer is equal to or smaller than Th1, it is further determined whether or not the proportion of the remaining capacity of the OPC area to the remaining capacity of a user data area of the recording object recording layer is larger than Th2. If the proportion is not larger than Th2, the recording conditions and the reproducing conditions can be determined using an OPC area of the other recording layer. Thus, the possibility that the recording conditions and the reproducing conditions cannot be determined due to the shortage of the remaining capacity of the OPC area of the recording object recording layer is smaller in comparison to conventional configurations. Moreover, the OPC areas can be used more effectively in comparison to conventional configurations, so that it is possible to increase the number of recording times.

### Third Embodiment

An optical disk device according to a third embodiment of the present invention is configured to be capable of recording and reproducing data also on an optical disk having three or more recording layers.

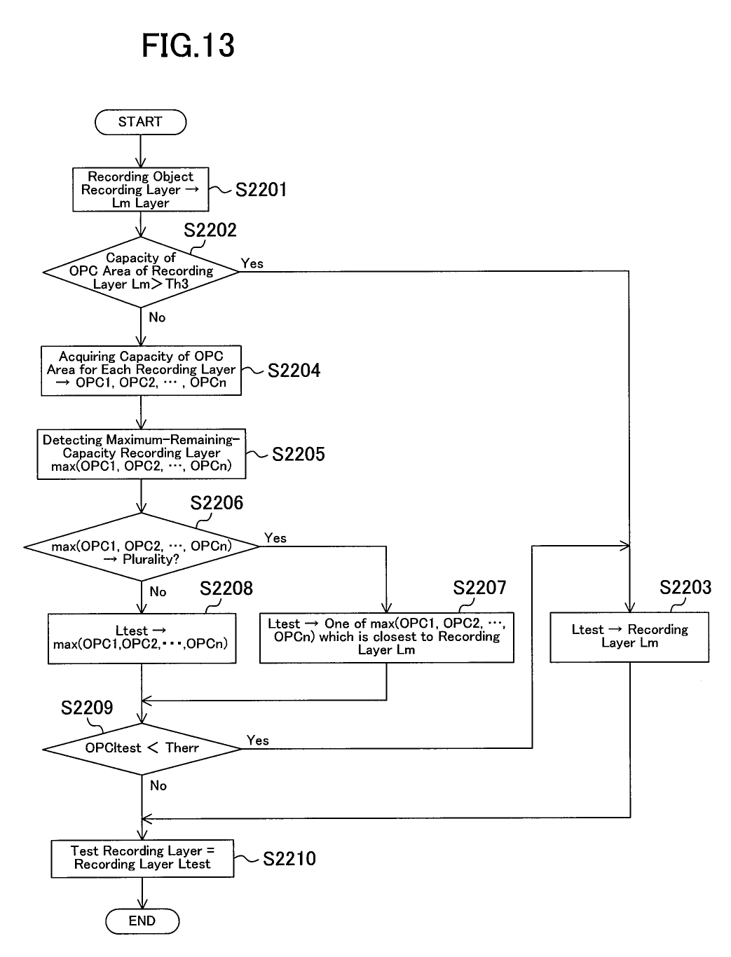

In the optical disk device of the present embodiment, a test recording layer determining unit 222 performs the process illustrated in FIG. 13 at (S2000) instead of the process of FIG. 5 of the first embodiment. Here, a BD-R disc 700 inserted in the optical disk device includes n recording layers L1-Ln (where n is an integer larger than or equal to 2).

First, at (S2201), the test recording layer determining unit 222 determines which one of the recording layers is a recording object recording layer on which user data will be recorded. Here, it is provided that the recording object recording layer is a recording layer Lm. Next, at (S2202), the test recording layer determining unit 222 determines whether or not the remaining capacity of an OPC area of the recording object recording layer Lm is larger than a predetermined value Th3. Then, if the remaining capacity of the OPC area of the recording object recording layer Lm is larger than the predetermined value Th3, the recording object recording layer Lm is stored as a recording layer Ltest at (S2203), and the process proceeds to (S2210).

In contrast, if it is determined at (S2202) that the remaining capacity of the OPC area of the recording object recording layer Lm is equal to or smaller than the predetermined value Th3, the test recording layer determining unit 222 acquires, at (S2204), the remaining capacities of the OPC areas for the recording layers acquired by the remaining capacity acquiring unit 221 at (S1000). Then, the test recording layer determining unit 222 extracts by an operation, at (S2205), a maximum-remaining-capacity recording layer(s) which is a recording layer on which the remaining capacity of the OPC area is maximum, and determines, at (S2206), whether or not there are a plurality of maximum-remaining-capacity recording layers. If there are a plurality of maximum-remaining-capacity recording layers, one of the plurality of maximum-remaining-capacity recording layers which is closest to the recording object recording layer Lm is stored as the recording layer Ltest at (S2207). In contrast, if there is only one maximum-remaining-capacity recording layer, this maximum-remaining-capacity recording layer is stored as the recording layer Ltest at (S2208). At (S2209), it is determined whether or not the remaining capacity OPC1test of the OPC area of the recording layer stored as the recording layer Ltest is smaller than a predetermined value Therr. If the remaining capacity OPC1test is smaller than the predetermined value Therr, the recording object recording layer Lm is stored as the recording layer Ltest at (S2203), and the process proceeds to (S2210). In contrast, if the remaining capacity OPC1test is equal to or larger than the predetermined value Therr, the process proceeds to (S2210).

It is determined at (S2210) that an OPC area in which test recording is intended to be made is the OPC area of the recording layer stored as the recording layer Ltest at (S2203), (S2207) or (S2208).

The other configuration and operation of the optical disk device of the present embodiment are the same as those of the first embodiment, and thus the detailed description thereof is omitted.

Thus, according to the present embodiment, if the remaining capacity of an OPC area of a recording object recording layer is larger than Th3, test recording is made in the OPC area of the recording object recording layer. As a result, recording conditions and reproducing conditions can be determined with high precision. In contrast, if the remaining capacity of the OPC area of the recording object recording layer is equal to or smaller than Th3, the test recording can be made on a recording layer of the BD-R disc 700 on which the remaining capacity of the OPC area is maximum. Thus, the possibility that the recording conditions and the reproducing conditions cannot be determined due to the shortage of the remaining capacity of the OPC area of the recording object recording layer is smaller in comparison to conventional configurations. Moreover, the OPC area can be used more effectively in comparison to conventional configurations, so that it is possible to increase the number of recording times. Moreover, a recording layer closer to the recording object recording layer generally has characteristics more similar to those of the recording object recording layer in comparison to a recording layer away from the recording object recording layer. Thus, when there are a plurality of maximum-remaining-capacity recording layers, test recording is made on one of the maximum-remaining-capacity recording layers which is closest to the recording object recording layer, so that the recording conditions and the reproducing conditions can be determined with high precision.

### Fourth Embodiment

In an optical disk device according to a fourth embodiment of the present invention, a remaining capacity acquiring unit 221 further acquires the remaining capacity of a user data area in addition to the remaining capacity of an OPC area for each of recording layers based on the record management data. Moreover, based on the remaining capacities of the user data areas for the recording layers in addition to the remaining capacities of the OPC areas for the recording layers acquired by the remaining capacity acquiring unit 221, a test recording layer determining unit 222 determines a recording layer on which test recording is intended to be made as a test recording layer.

By the optical disk device of the present embodiment, the remaining capacity acquiring unit 221 further acquires the remaining capacity of the user data area in addition to the remaining capacity of the OPC area for each of the recording layers at (S1000). Here, the remaining capacity of the OPC area may be acquired first, or the remaining capacity of the user data area may be acquired first.

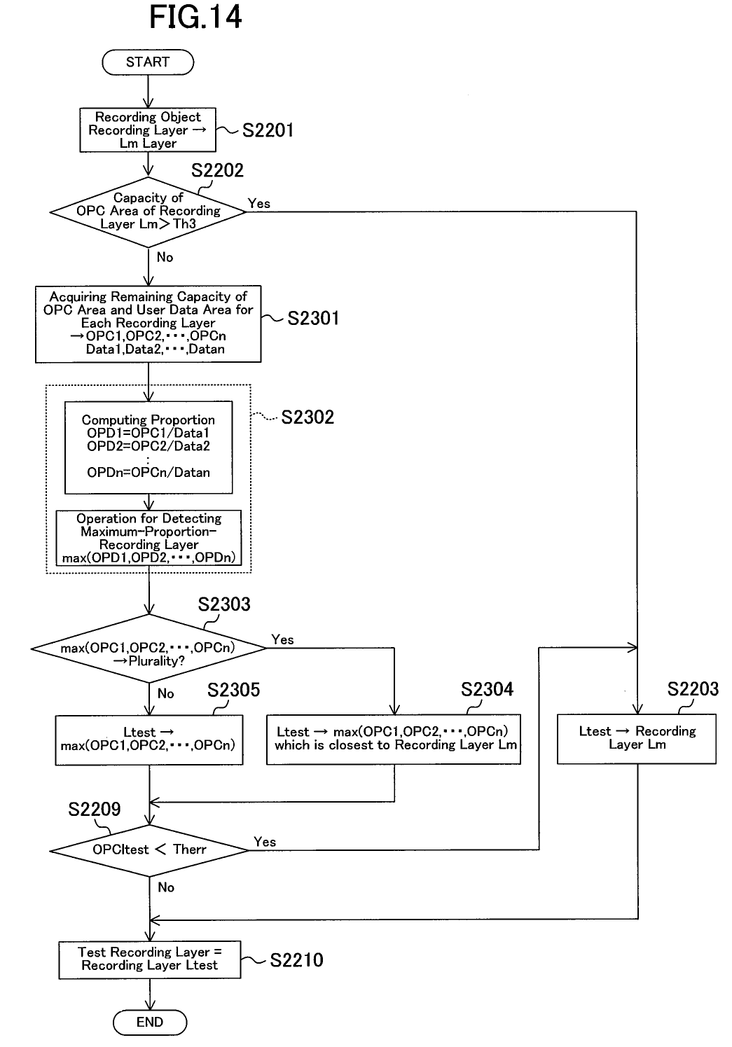

Moreover, in the optical disk device of the present embodiment, the test recording layer determining unit 222 performs the process illustrated in FIG. 14 at (S2000) instead of the process of FIG. 13 of the third embodiment.

Note that the processes at (S2201)-(S2203), (S2209), and (S2210) of FIG. 14 are the same as those described using the same reference symbols in FIG. 13 of the third embodiment, and thus the description thereof is omitted.

At (S2301), the test recording layer determining unit 222 acquires the remaining capacity of the OPC area, and the remaining capacity of the user data area for each of the recording layers acquired by the remaining capacity acquiring unit 221 at (S1000). Subsequently, at (S2302), the proportion (ratio) of the remaining capacity of the OPC area to the remaining capacity of the user data area is computed for each recording layer excepting the recording object recording layer Lm, and a maximum-proportion recording layer(s) which is a recording layer for which a maximum proportion is computed is extracted by an operation. Then, at (S2303), it is determined whether or not there are a plurality of maximum-proportion recording layers extracted at (S2302). If there are a plurality of maximum-proportion recording layers, one of the plurality of maximum-proportion recording layers which is closest to the recording object recording layer Lm is stored as a recording layer Ltest at (S2304). In contrast, if there is only one maximum-proportion recording layer, this maximum-proportion recording layer is stored as the recording layer Ltest at (S2305).

The other configuration and operation of the optical disk device of the fourth embodiment are the same as those of the third embodiment, and thus the detailed description thereof is omitted.

Thus, according to the present embodiment, if the remaining capacity of an OPC area of a recording object recording layer is larger than Th3, test recording is made in the OPC area of the recording object recording layer. As a result, recording conditions and reproducing conditions can be determined with high precision. In contrast, if the remaining capacity of the OPC area of the recording object recording layer is equal to or smaller than Th3, the test recording can be made on a recording layer of the BD-R disc 700 on which the proportion of the remaining capacity of the OPC area to the remaining capacity of the user data area is maximum. Thus, the possibility that the recording conditions and the reproducing conditions cannot be determined due to the shortage of the remaining capacity of the OPC area of the recording object recording layer is smaller in comparison to conventional configurations. Moreover, the OPC area can be used more effectively in comparison to conventional configurations, so that it is possible to increase the number of recording times. Moreover, a recording layer closer to the recording object recording layer generally has characteristics more similar to those of the recording object recording layer in comparison to a recording layer away from the recording object recording layer. Thus, when there are a plurality of maximum-proportion recording layers, test recording is made on one of the maximum-proportion recording layers which is closest to the recording object recording layer, so that the recording conditions and the reproducing conditions can be determined with high precision.

### Fifth Embodiment

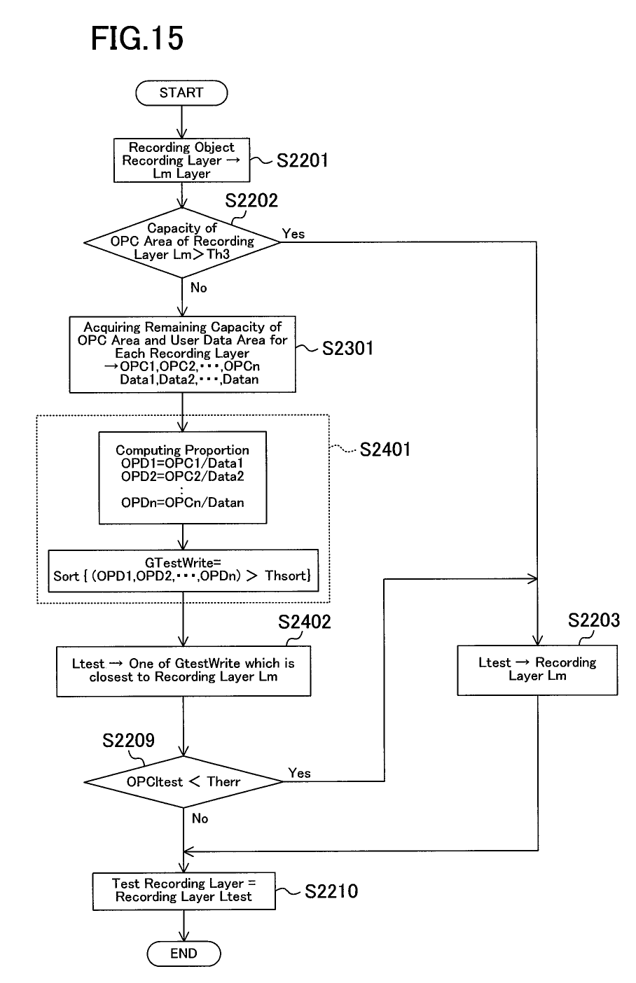

Moreover, in the optical disk device of a fifth embodiment of the present invention, a test recording layer determining unit 222 performs the process illustrated in FIG. 15 at (S2000) instead of the process of FIG. 14 of the fourth embodiment.

Note that the processes at (S2201)-(S2203), (S2209), (S2210), and (S2301) of FIG. 15 are the same as those described using the same reference symbols in FIGS. 13 and 14 of the third and fourth embodiments, and thus the description thereof is omitted.

At (S2401), the proportion (ratio) of the remaining capacity of an OPC area to the remaining capacity of a user data area is computed for each recording layer excepting the recording object recording layer Lm, and recording layers in each of which the computed proportion is larger than a predetermined value Thsort are extracted as a group GtestWrite of the recording layers. Subsequently, at (S2402), one of the recording layers extracted at (S2401) which is closest to the recording object recording layer Lm is stored as a recording layer Ltest.

The other configuration and operation of the optical disk device of the fifth embodiment are the same as those of the fourth embodiment, and thus the detailed description thereof is omitted.

Thus, according to the present embodiment, if the remaining capacity of an OPC area of a recording object recording layer is larger than Th3, test recording is made in the OPC area of the recording object recording layer. As a result, recording conditions and reproducing conditions can be determined with high precision. In contrast, if the remaining capacity of the OPC area of the recording object recording layer is equal to or smaller than Th3, of the recording layers of the BD-R disc 700 on each of which the proportion of the remaining capacity of the OPC area to the remaining capacity of the user data area is larger than the predetermined value Thsort, the test recording can be made on a recording layer which is closest to the recording object recording layer. Thus, the possibility that the recording conditions and the reproducing conditions cannot be determined due to the shortage of the remaining capacity of the OPC area of the recording object recording layer is smaller in comparison to conventional configurations. Moreover, the OPC area can be used more effectively in comparison to conventional configurations, so that it is possible to increase the number of recording times. Moreover, a recording layer closer to the recording object recording layer has characteristics more similar to those of the recording object recording layer in comparison to a recording layer away from the recording object recording layer. Thus, in comparison to the case where test recording is made on a recording layer away from the recording object recording layer, the recording conditions and the reproducing conditions can be determined with higher precision.

### Sixth Embodiment

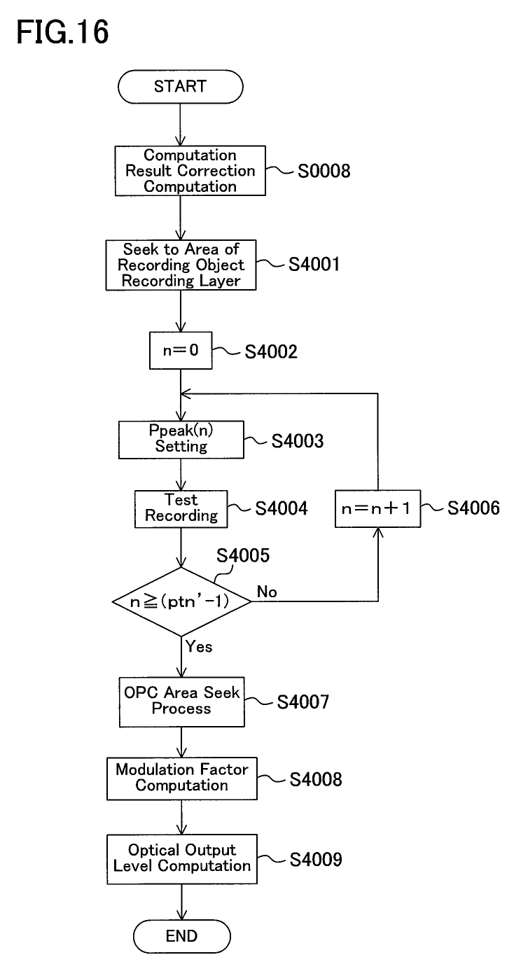

An optical disk device according to a sixth embodiment of the present invention performs the process illustrated in FIG. 16 instead of the process at (S0008) of the first embodiment when the test recording layer determined at (S2000) to be a recording layer on which test recording is intended to be made does not correspond to the recording object recording layer.

In the process of FIG. 16, a recording/reproducing condition determining unit 223 first performs the process of (S0008). That is, the adjustment parameters, the optical output level, and the optical pulse width computed at (S0003), (S0005), and (S3000) are corrected using the values of Table 1.

Then, at (S4001), the optical disk device allows an optical head 100 to seek to an OPC area of the recording object recording layer. Next, at (S4002), the internal variable n is reset. Sequentially, at (S4003), the optical output level Ppeak is set to Ppeak(n), and then the test recording is made at (S4004). At (S4005), it is determined whether or not n≧ptn′−1. If not n≧ptn′−1, then 1 is added to n at (S4006). If n≧ptn′−1, the process proceeds to (S4007).

At (S4003)-(S4006), the test recording is made with the optical output level being varied within the range from Ppeak(0)-Ppeak(ptn′−1). The range from Ppeak(0)-Ppeak(ptn′−1) is set in consideration of characteristics of a semiconductor laser 101 and recording characteristics of a BD-R disc 700 as described in the first embodiment of FIG. 11.

Note that at (S4003), Ppeak(0)-Ppeak(ptn′−1) are set to values stepwise varied in a predetermined range based on the optical output level obtained by the correction at (S0008). For example, Ppeak(0)-Ppeak(ptn′−1) are set to values stepwise varied within a range where the optical output level corrected at (S0008) is defined as the center level, and levels obtained by adding and subtracting a design value according to variations of the recording characteristics of the disk to and from the center level are upper and lower limits, respectively. The optical output level obtained by the correction at (S0008) is an optical output level adjusted for the test recording layer determined at (S2000), and thus can also be expected to serve as an almost optimal value as an optical output level of the recording object recording layer.

As a result, the variations of the characteristics of the semiconductor laser 101 are no longer necessary to be taken into consideration. Thus, the range from Ppeak(0)-Ppeak(ptn′−1) can be narrower than the range of the optical output levels Ppeak(0)-Ppeak(ptn−1) set at (S3000). Thus, ptn′ is set to a value smaller than 2, which is smaller than ptn.

Then, the optical head 100 is allowed at (S4007) to seek to the area in which the test recording has been made at (S4003)-(S4006), and a modulation factor of the area is computed at (S4008). Subsequently, at (S4009), Pth is computed as described above with reference to FIGS. 9A and 9B based on the relationship between the optical output level Ppeak and m×Ppeak. By substituting the computed Pth into the equations (1)-(4), the optical output levels Ppeak, Pspace, Pcool, and Pbias are computed. Then, these optical output levels Ppeak, Pspace, Pcool, and Pbias computed based on the modulation factor acquired at (S4008) are determined to be optical output levels Ppeak, Pspace, Pcool, and Pbias at the time of recording user data in the recording object recording layer. Note that to perform the processes at (S4001)-(S4006), the test recording unit 224 controls the driving unit 400 and the transport motor 600 (indirectly controls the optical head 100).

Thus, according to the present embodiment, if the recording layer on which the test recording has been made at (S0001) and (S3000) does not correspond to the recording object recording layer, test recording is made in the OPC area of the recording object recording layer, and based on the recording quality of the test-recorded area, the optical output levels Ppeak, Pspace, Pcool, and Pbias are determined, so that a more precise optical output level can be obtained. Moreover, ptn′ is set to a smaller number, so that it is possible to reduce the usage capacity of the OPC area of the recording object recording layer.

Note that not only the optical output levels Ppeak, Pspace, Pcool, and Pbias but also other recording conditions and reproducing conditions such as target positions (focus offset and tracking offset) of the focus control and the tracking control may be determined based on the recording quality of the area in which the test recording has been made at (S4003)-(S4006).

Moreover, in the present embodiment, the optical output levels Ppeak(0)-Ppeak(ptn′−1) used for the test recording made in the OPC area of the recording object recording layer (the test recording at (S4004)) are set based on the optical output levels obtained at (S0008). However, Ppeak(0)-Ppeak(ptn′−1) at the test recording at (S4004) may be set based on the optical output levels computed at (S3000) without performing the correction process at (S0008). In any case, the optical output levels Ppeak(0)-Ppeak(ptn′−1) are set to values based on the recording quality of the test-recorded area of the test recording layer.

### Other Embodiments

Note that the remaining capacity of the OPC0 and the remaining capacity of the OPC1 are both compared with the same predetermined value Th1 in the first and second embodiments, but may be compared with different predetermined values. Moreover, in the second embodiment, the proportion of the remaining capacity of the OPC0 to the remaining capacity of the user data area of the L0 layer and the proportion of the remaining capacity of the OPC1 to the remaining capacity of the user data area of the L1 layer are both compared with the predetermined value Th2, but may be compared with different predetermined values.

Moreover, in the first to sixth embodiments, the optical disk device determines both recording conditions at the time of recording user data in a recording object recording layer and reproducing conditions at the time of reproducing the data from the recording object recording layer, but may determine one of the recording conditions or the reproducing conditions. For example, in the third, fourth, and fifth embodiments, at least one of (S2202) or (S2209) may not be performed. Alternatively, at least one or more of the recording conditions and the reproducing conditions mentioned in the first to sixth embodiments may be determined. Furthermore, the present invention may be applied to determine recording conditions or reproducing conditions which are not mentioned in the first to sixth embodiments.

Moreover, in the first to sixth embodiments, any one or two of (S0003), (S0005), and (S3000) may be performed.

Moreover, in the fifth embodiment, after recording layers on each of which the proportion of the remaining capacity of the OPC area to the remaining capacity of the user data area is larger than the predetermined value Thsort are extracted, one of the extracted recording layers which is closest to the recording object recording layer Lm is stored as the recording layer Ltest. However, it may be determined for recording layers, sequentially from one of the recording layers which is closest to the recording object recording layer Lm, whether or not the above proportion of the respective recording layer is larger than the predetermined value Thsort. Then, a recording layer which is first determined that the above proportion thereof is larger than the predetermined value Thsort may be stored as the recording layer Ltest.

Moreover, an optical disk device for recording and reproducing data on the BD-R disc 700 has been described in the first to sixth embodiments, but the present invention can be applied to devices for recording and reproducing data on other optical recording media.

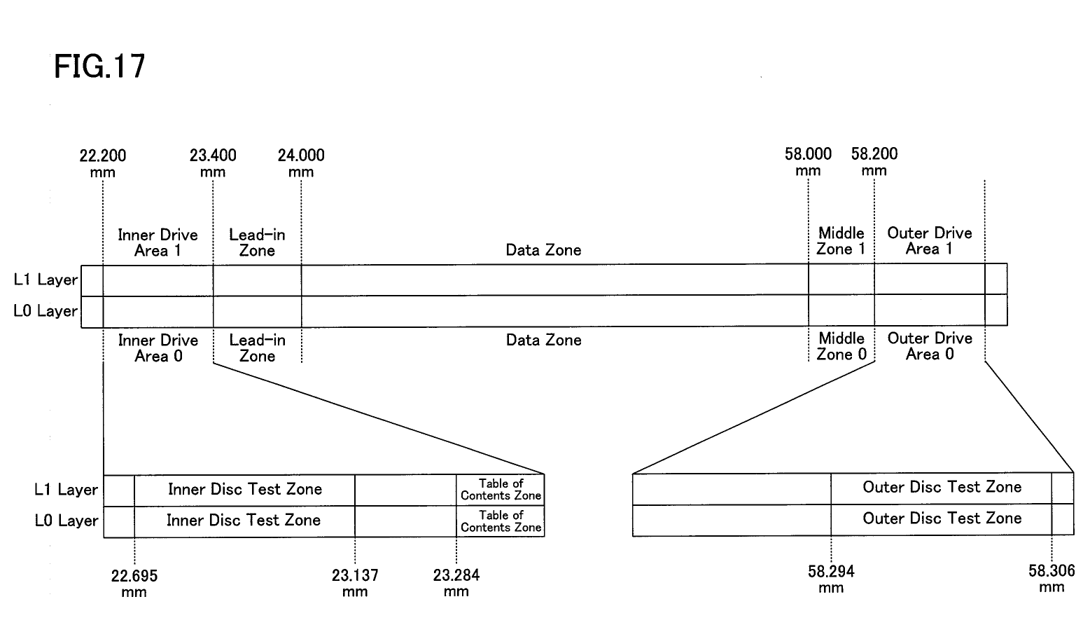

For example, the processes of the present invention can be performed on DVD+R discs. FIG. 17 is a view illustrating a format of a DVD+R (Dual Layer) disc. The DVD+R disc includes an inner drive area (represented by Inner Drive Area n in FIG. 17: n indicates the numeral of the recording layer) extending from 22.200 mm to 23.400 mm in radius, a lead-in area (represented by Lead-in Zone in FIG. 17) extending in the L0 layer from 23.400 mm to 24.000 mm in radius, a lead-in area (represented by Lead-in Zone in FIG. 17) extending in the L1 layer from 23.400 mm to 24.000 mm in radius, a data area (represented by Data Zone in FIG. 17) extending from 24.000 mm to 58.000 mm in radius, a middle zone (represented by Middle Zone n in FIG. 17: n indicates the numeral of the recording layer) extending from 58.000 mm to 58.200 mm in radius, and an outer drive area (represented by Outer Drive Area n in FIG. 17: n indicates the numeral of the recording layer) extending from 58.200 mm to 58.306 mm in radius.

Here, an inner disk test zone and an outer disk test zone are respectively provided within the inner drive area and the outer drive area. For more details, as illustrated in FIG. 17, the inner disk test zone is provided in an inner circumference area (22.695 mm-23.137 mm in radius), whereas the outer disk test zone is provided in an outer circumference area (58.294 mm-58.306 mm in radius) of the DVD+R disc. Test recording can be made in the inner disk test zone and the outer disk test zone with the optical output level and the optical pulse width being varied, and the test-recorded recording area is played back, thereby obtaining recording conditions under which the quality of the reproduction signal is optimal. That is, the inner disk test zone and the outer disk test zone have a similar function to that of the OPC areas of the BD-R disc.

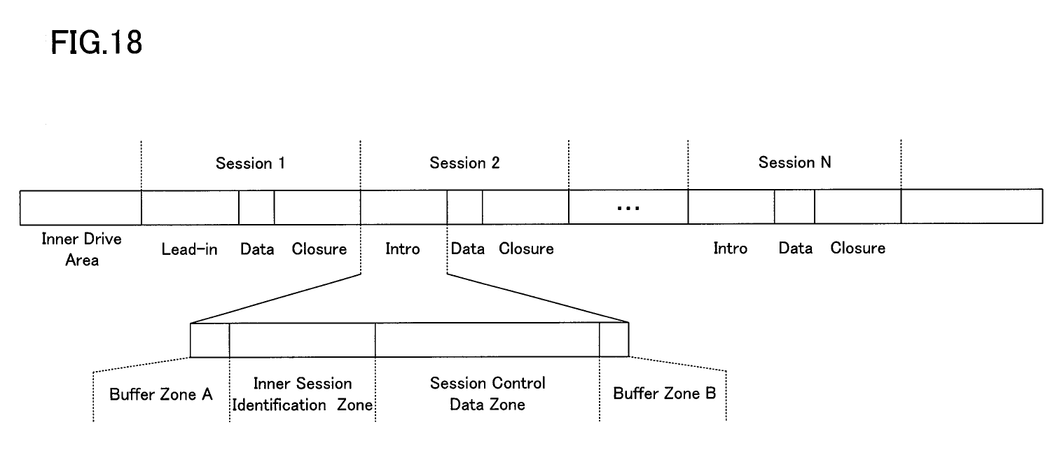

Moreover, the DVD+R disc includes TOC zones (represented by Table of Contents Zone in FIG. 17). These TOC zones have a similar function to that of the TDMA areas of the BD-R disc. The recording area of the DVD+R disc includes a plurality of sessions, and recording on the DVD+R disc is performed in session unit. Then, start/finish address information of each session is recorded in the TOC zones. In each session, recording information indicating a recorded area of the session is recorded. FIG. 18 shows a format of the DVD+R disc on which a plurality of sessions (n sessions in FIG. 18, where n is an integer equal to or larger than 2) is recorded. Each session includes an intro zone, a data zone, and a closure zone. An inner session identification zone (represented by Inner Session Identification Zone in FIG. 18) within the intro zone is played back to check the usage of the data area as the usage (recorded) state of the user data area.

As described above, even when a DVD+R disc is inserted in the optical disk device, the remaining capacity of the disk test zone and the data zone can be detected by playing back the TOC zone within the inner drive area and the intro zone of each session. Thus, a recording layer on which test recording is intended to be made can be determined in the same manner as in the first to sixth embodiments, and the test recording can be made on the disk test zone of the determined recording layer.

Moreover, the present invention can equally be applied to disks under various standards already in practical use, for example, DVD-Rs (Dual Layer), DVD±RWs (Dual Layer), and BD-REs (Blu-ray Disc Rewritable) (Dual Layer).

Moreover, in the first to sixth embodiments, the remaining capacity of the OPC area is obtained for each recording layer using data in the TDMA area, but when the present invention is applied to an optical recording medium under another standard, data on a recorded track or in another area in which address information is recorded may be used instead of the data in the TDMA area.

Moreover, in the first to sixth embodiments, the OPC area is used as a test recording area, but when the present invention is applied to an optical recording medium under another standard, another area used for test recording (pre-recording), for example, a PCA area, a drive test zone, or the like may be used instead of the OPC area.

Moreover, in the first to sixth embodiments, at (S3000), the coefficients κ, ρ, εs, εc, and εbw used to compute optical output levels are obtained by playing back the PIC area, but may be obtained by previously storing set coefficients in the optical disk device, and reading out the stored coefficients.

Furthermore, when the present invention is applied to DVDs and CDs, test recording can be made with recording conditions being varied in various types so that the test recording is made in one ECC block or one sector under each recording condition.

The method for determining recording conditions or reproducing conditions, the integrated circuit, and the optical disk device according to the present invention have advantages that the situation in which the recording conditions and the reproducing conditions cannot be determined due to the shortage of the remaining capacity of the test recording area can be prevented, and that the test recording area can effectively be used to increase the number of recording times, and are useful as, for example, a technique to determine the recording conditions and the reproducing conditions by making test recording by a recording/reproducing device which irradiates an optical recording medium with laser light to record and reproduce data.

1. A method which is performed by a recording/reproducing device configured to irradiate an optical recording medium including a plurality of recording layers with laser light to record and reproduce data, and is for determining at least one of a recording condition at the time of recording user data on any one recording object recording layer of the recording layers, or a reproducing condition at the time of reproducing the data from the recording object recording layer, where each of the recording layers has a test recording area and a user data area, and record management data indicating a recorded area on the recording layers is recorded on the optical recording medium, the method comprising:
a remaining capacity acquiring step for acquiring a remaining capacity of the test recording area for each of the recording layers based on the record management data;
a test recording layer determining step for determining a recording layer on which test recording is intended to be made as a test recording layer based on the remaining capacities of the test recording areas for the recording layers acquired in the remaining capacity acquiring step;
a test recording step for making the test recording in the test recording area of the test recording layer determined in the test recording layer determining step; and
a condition determining step for determining at least one of the recording condition or the reproducing condition based on recording quality of the area in which the test recording has been made in the test recording step.

2. The method of claim 1, wherein
in the test recording layer determining step, if the remaining capacity of the test recording area of the recording object recording layer is larger than a predetermined value, the recording object recording layer is determined as the test recording layer.

3. The method of claim 1, wherein
in the test recording layer determining step, a maximum-remaining-capacity recording layer which is a recording layer on which the remaining capacity of the test recording area is maximum is determined as the test recording layer.

4. The method of claim 3, wherein
in the test recording layer determining step, if there are multiple ones of the maximum-remaining-capacity recording layer, one of the maximum-remaining-capacity recording layers which is closest to the recording object recording layer is determined as the test recording layer.

5. The method of claim 1, wherein
in the remaining capacity acquiring step, a remaining capacity of the user data area for each of the recording layers is further acquired based on the record management data, and
in the test recording layer determining step, the test recording layer is determined based on the remaining capacities of the user data areas for the recording layers acquired in the remaining capacity acquiring step in addition to the remaining capacities of the test recording areas for the recording layers.

6. The method of claim 5, wherein
in the test recording layer determining step, if a proportion of the remaining capacity of the test recording area to the remaining capacity of the user data area on the recording object recording layer is larger than a predetermined value, the recording object recording layer is determined as the test recording layer.

7. The method of claim 5, wherein
in the test recording layer determining step, a maximum-proportion recording layer which is a recording layer on which the proportion of the remaining capacity of the test recording area to the remaining capacity of the user data area is maximum is determined as the test recording layer.

8. The method of claim 7, wherein
in the test recording layer determining step, if there are multiple ones of the maximum-proportion recording layer, one of the maximum-proportion recording layers which is closest to the recording object recording layer is determined as the test recording layer.

9. The method of claim 5, wherein
in the test recording layer determining step, of the recording layers on each of which a proportion of the remaining capacity of the test recording area to the remaining capacity of the user data area is larger than a predetermined value, a recording layer which is closest to the recording object recording layer is determined as the test recording layer.

10. The method of claim 5, wherein
in the test recording layer determining step, if the remaining capacity of the test recording area of the recording object recording layer is larger than a predetermined value, the recording object recording layer is determined as the test recording layer.

11. The method of claim 1, wherein
in the condition determining step, at least one of the recording condition or the reproducing condition is determined in consideration of a combination of the test recording layer and the recording object recording layer in addition to the recording quality.

12. The method of claim 1, wherein
in the condition determining step, if the test recording layer does not correspond to the recording object recording layer,
test recording is made in the test recording area of the recording object recording layer at a plurality of types of optical output levels which are set based on the recording quality of the area in which the test recording has been made in the test recording step, and
at least one of the recording condition or the reproducing condition is determined based on recording quality of the test-recorded area of the recording object recording layer.

13. The method of claim 1, wherein
at least one of an optical output level or an optical pulse width of the laser light is determined as the recording condition.

14. The method of claim 1, wherein
at least one of the following is determined as the reproducing condition:
a boost value of an equalizer circuit which equalizes a reproduction signal obtained by reproducing the user data;
a cutoff frequency of the equalizer circuit;
a focus offset;
a tracking offset;
a tilt of an objective lens for gathering laser light with which the optical recording medium is irradiated; and
aberration.

15. An integrated circuit which is provided in a recording/reproducing device configured to irradiate an optical recording medium including a plurality of recording layers with laser light by an optical head to record and reproduce data, and is for determining at least one of a recording condition at the time of recording user data on any one recording object recording layer of the recording layers, or a reproducing condition at the time of reproducing the data from the recording object recording layer, where each of the recording layers has a test recording area and a user data area, and record management data indicating a recorded area on the recording layers is recorded on the optical recording medium, the integrated circuit comprising:
a remaining capacity acquiring unit for acquiring a remaining capacity of the test recording area for each of the recording layers based on the record management data;
a test recording layer determining unit for determining a recording layer on which test recording is intended to be made as a test recording layer based on the remaining capacities of the test recording areas for the recording layers acquired by the remaining capacity acquiring unit;
a test recording unit for controlling the optical head such that the test recording is made in the test recording area of the test recording layer determined by the test recording layer determining unit; and
a condition determining unit for determining at least one of the recording condition or the reproducing condition based on recording quality of the area in which the test recording has been made by the test recording unit.

16. The integrated circuit of claim 15, wherein
if the remaining capacity of the test recording area of the recording object recording layer is larger than a predetermined value, the test recording layer determining unit determines the recording object recording layer as the test recording layer.

17. The integrated circuit of claim 15, wherein
the test recording layer determining unit determines a maximum-remaining-capacity recording layer which is a recording layer on which the remaining capacity of the test recording area is maximum as the test recording layer.

18. The integrated circuit of claim 17, wherein
if there are multiple ones of the maximum-remaining-capacity recording layer, the test recording layer determining unit determines one of the maximum-remaining-capacity recording layers which is closest to the recording object recording layer as the test recording layer.

19. The integrated circuit of claim 15, wherein
the remaining capacity acquiring unit further acquires a remaining capacity of the user data area for each of the recording layers based on the record management data, and
the test recording layer determining unit determines the test recording layer based on the remaining capacities of the user data areas for the recording layers acquired by the remaining capacity acquiring unit in addition to the remaining capacities of the test recording areas for the recording layers.

20. The integrated circuit of claim 19, wherein
if a proportion of the remaining capacity of the test recording area to the remaining capacity of the user data area on the recording object recording layer is larger than a predetermined value, the test recording layer determining unit determines the recording object recording layer as the test recording layer.

21. The integrated circuit of claim 19, wherein
the test recording layer determining unit determines a maximum-proportion recording layer which is a recording layer on which the proportion of the remaining capacity of the test recording area to the remaining capacity of the user data area is maximum as the test recording layer.

22. The integrated circuit of claim 21, wherein
if there are multiple ones of the maximum-proportion recording layer, the test recording layer determining unit determines one of the maximum-proportion recording layers which is closest to the recording object recording layer as the test recording layer.

23. The integrated circuit of claim 19, wherein
of the recording layers on each of which a proportion of the remaining capacity of the test recording area to the remaining capacity of the user data area is larger than a predetermined value, the test recording layer determining unit determines a recording layer which is closest to the recording object recording layer as the test recording layer.

24. The integrated circuit of claim 19, wherein
if the remaining capacity of the test recording area of the recording object recording layer is larger than a predetermined value, the test recording layer determining unit determines the recording object recording layer as the test recording layer.

25. The integrated circuit of claim 15, wherein
the condition determining unit determines at least one of the recording condition or the reproducing condition in consideration of a combination of the test recording layer and the recording object recording layer in addition to the recording quality.

26. The integrated circuit of claim 15, wherein
if the test recording layer does not correspond to the recording object recording layer,
the test recording unit controls the optical head such that test recording is made in the test recording area of the recording object recording layer at a plurality of types of optical output levels which are set based on the recording quality of the area of the test recording layer in which the test recording has been made, and
the condition determining unit determines at least one of the recording condition or the reproducing condition based on recording quality of the test-recorded area of the recording object recording layer.

27. The integrated circuit of claim 15, wherein
at least one of an optical output level or an optical pulse width of the laser light is determined as the recording condition.

28. The integrated circuit of claim 15, wherein
at least one of the following is determined as the reproducing condition:
a boost value of an equalizer circuit which equalizes a reproduction signal obtained by reproducing the user data;
a cutoff frequency of the equalizer circuit;
a focus offset;
a tracking offset;
a tilt of an objective lens for gathering laser light with which the optical recording medium is irradiated; and
aberration.

29. An optical disk device comprising:
the integrated circuit of claim 15; and
the optical head, wherein
the optical recording medium is an optical disk.
